(19) United States
(12) Patent Application Publication
(10) Pub. No.: US 2013/0298155 A1
(43) Pub. Date: Nov. 7, 2013

(54) VIDEO PERSONAL IDENTIFICATION CODE FOR VIDEO ON DEMAND SERVICES

(71) Applicant: Sergey Stepanov, Sankt-Petersburg (RU)

(72) Inventor: Sergey Stepanov, Sankt-Petersburg (RU)

(73) Assignee: RAWLLIN INTERNATIONAL INC., Tortola (VG)

(21) Appl. No.: 13/463,776

(22) Filed: May 3, 2012

(51) Int. Cl. H04N 21/4367

(52) U.S. Cl. 725/31; 725/25

(57) ABSTRACT

The subject disclosure provides for user account authorization in conjunction with online multimedia television content services. By way of example, a network-enabled television device can request a video identification code in response to a power-on event. A set of video data comprising a picture of a distinct identification code can be received from a network server in response to the request. The video data can be played on a video display of the television device, to facilitate verifying that a user or viewer of the television device maintains a subscription account associated with online multimedia television services. Upon successful verification, the television device can be linked with the subscription account, and promotional content or services associated with the verification can be allocated to the subscription account.

### TECHNICAL FIELD

The subject application relates generally to video on demand content services, and more particularly to employing a video personal identification code in conjunction with offering or verifying a user in relation to the video on demand content services.

### BACKGROUND

The advent of the Internet and widespread consumer access to network-stored multimedia content has dramatically changed markets for consumer television, and consumer multimedia. Much of the change has been driven by advancements in networking technology, as has been typical with the Internet revolution of the past decades. As examples, from the perspective of content providers, real-time streaming media codecs (e.g. streaming audio, streaming video, streaming multi-media, . . . ) have enabled provisioning of content to individual subscribers, and control over the amount of content, type of content, transmission bandwidth, and other factors related to real-time provision of content. From the perspective of the content subscriber, or end user, last-mile Internet Protocol service has enabled data rates suitable for streaming multimedia content, even high definition streaming multimedia content. These and related technical achievements have spurred significant consumer demand for network-stored multimedia, while giving content providers mechanisms for controlling delivery of content, as well as protecting the Intellectual property rights (e.g., copyrights associated with content) of content owners, and the like.

One popular market for network-stored multimedia content is network television content. Network television services typically involve delivering audio and video content over a network connection (e.g., an Internet connection, an intranet connection, . . . ) to a television device that in turn is configured to communicate via its own network connection, and receive and playback the audio and video content. Network television services provide several advantages over traditional broadcast or cable television services. First, network television content can generally be stored persistently on a network data store, and accessed through a multi-access server, meaning multiple client devices (e.g., network-enabled television, personal computer, laptop computer, smart phone, tablet computer, . . . ) can access and consume the television content at their initiation; a provider of the network television content is not required to initiate transmission of a particular program to the client devices. This results in a far greater degree of consumer-directed control over content with far fewer channels than are typically required for broadcast television services. Second, network television content can leverage existing network communication pathways, in effect reducing the overall infrastructure equipment associated with delivering television services, radio services, or other multimedia content services, and general network data services (e.g., web browsing, online shopping, . . . ) to consumers. Third, by leveraging public networks, like the Internet, and existing access to those networks, a more direct connection between service provider and consumer is possible, with relatively direct client-server communication between the consumer and service provider. This, along with reduced content delivery infrastructure, results in content delivery more quickly, efficiently and at greatly reduced cost, benefiting both the service provider and consumer.

Because of the significant benefits of network multimedia content delivery, various service providers exist providing various types of content. Some of the first Internet media content involved network audio, which was more commensurate with widely available consumer bandwidth limitations. As consumer Internet bandwidths increased, e.g., in response to emergence of integrated digital service line [ISDN] and digital subscriber line (SDL) technologies, video and audio/video content providers emerged. Initial multimedia content was primarily available for consumption with a personal computing device, and not on a traditional radio or television. But as audio or video devices with built-in or plug-in network interfaces became available, this limitation changed. More recently, network-enabled television devices have become more common, and coupled with widespread consumer access to high speed broadband Internet, online television content has also become widely available, even high definition television content. Accordingly, a number of television content providers have entered this market to provide low cost, high quality online television services.

Because network multimedia content is managed via client-server communications over a network, client authorization and user verification procedures are employed to control client access to content. A server might, for instance, be provisioned to check that a client device is associated with a subscription account offered by a particular content provider. This allows a service provider to limit content delivery only to those users who have an agreement with the service provider, as well as protect intellectual property rights of content owners. As the type and sophistication of playback devices evolve, different user authorization schemes are developed to best meet requirements of content providers. This evolution in technology is ongoing, and is one of many current challenges related to online multimedia content delivery.

### SUMMARY

The following description and the annexed drawings set forth in detail certain illustrative aspects of the disclosed subject matter. These aspects are indicative, however, of but a few of the various ways, or embodiments, in which the principles of the disclosed subject matter may be implemented. The disclosed subject matter is intended to include all such embodiments and their equivalents. Other advantages and distinctive features of the disclosed subject matter will become apparent from the following detailed description of the various embodiments when considered in conjunction with the drawings.

In various disclosed aspects, the subject disclosure provides for user account authorization in conjunction with multimedia television content services. Upon being activated, a network-enabled television or other suitable television display device can request a video identification code (e.g., a personal identification code, or PIN) from a user authorization server. The video identification code can be generated as a picture and converted into a video file by the user authorization server, and provided to the network-enabled television. In turn, the network-enabled television can be configured to play back the video file, thereby displaying the video identification code on a video display of the network-enabled television to a user or viewer. The user authorization server can then monitor user subscription logins for a subscriber login that includes the video identification code. Upon identifying a code that matches the generated code as part of a valid subscriber account login associated with online multimedia television content services, the subscription account can be linked with the network-enabled television, or a related device that requested the video identification code. By utilizing the video identification code for user authentication, a content authorization server can differentiate a television or related device being operated by an actual person with a valid subscription account with a content provider from an unauthorized computer or program that attempts to access content improperly.

In a particular aspect, disclosed is a system for securing content services at a network-enabled television, utilizing an electronic communication network. The system can comprise a network component configured to initiate a communication with a network server associated with the content services over the electronic communication network. Additionally, the system can comprise a query component configured to send a request for a video verification file to the network server, the video verification file comprising a set of video-encoded data. Furthermore, the system can comprise a playback component configured to obtain the video verification file in response to the request and play the set of video-encoded data on the network-enabled television.

According to another aspect(s), a system is disclosed. The system can comprise a memory storing computer-executable components and a processor communicatively connected to the memory and configured to facilitate execution of at least one of the computer-executable components. Particularly, the computer-executable components can comprise a communication component configured to receive a request for a verification code over a communication network and a code engine configured to generate a distinct verification code in response to the request, and to store the distinct verification code in a data store. Further, the computer-executable components can comprise an encoding component configured to create the distinct verification code as a picture and convert the picture of the distinct verification code into a set of video frames, wherein the communication component responds to the request at least in part with reference to the set of video frames. The computer-executable components can also comprise a verification component configured to receive data over the communication network and determine whether the received data comprises the distinct verification code, and further configured to link a display device to a network content user account related to the system in response to the received data comprising the distinct verification code.

According to one or more additional aspects, disclosed is a method of providing network media content. The method can comprise initiating an application on a television device, the application related to facilitating authorization of a user of the television device to receive network media content on the television device. Further, the method can comprise accessing a communication network in response to the initializing the application and sending a request to a network server for an authorization video. Additionally, the method can comprise receiving a video file in response to the request, the video file comprising an identification code rendered in the form of the video file. Moreover, the method can also comprise playing the video file on the television device to facilitate user submission of the identification code as a response to the network server.

In at least one additional aspect of the subject disclosure, provided is a system that can comprise means for initiating an application on a television device, the application related to facilitating authorization of a user of the television device to receive network media content on the television device. The system can also comprise means for accessing a communication network in response to the initializing the application and sending a request to a network server for an authorization video and means for receiving a video file in response to the request, the video file comprising an identification code rendered in the form of the video file. Moreover, the system can comprise means for playing the video file on the television device to facilitate user submission of the identification code as a response to the network server.

The following description and the annexed drawings set forth in detail certain illustrative aspects of the disclosed subject matter. These aspects are indicative, however, of but a few of the various ways in which the principles of the innovation can be employed and the disclosed subject matter is intended to include all such aspects and their equivalents. Other advantages and novel features of the disclosed subject matter will become apparent from the following detailed description of the innovation when considered in conjunction with the drawings.

### BRIEF DESCRIPTION OF THE DRAWINGS

FIG. 1 depicts a block diagram of a sample system configured to facilitate user authorization for online multimedia content delivery, in disclosed aspects.

FIG. 2 illustrates a block diagram of an example network-enabled television that can be employed for online user authorization in a further aspect.

FIG. 3 depicts a block diagram of a sample client-server interaction associated with user authorization in a client-server communication environment.

FIG. 4 depicts a block diagram of an example system configured to employ video identification coding for authorizing user access to online content.

FIG. 5 illustrates a block diagram of a sample system configured to facilitate account verification and administer bonus subscriber content, in an aspect(s).

FIG. 6 depicts a block diagram of a sample network-enabled television according to one or more further aspects of the subject disclosure.

FIG. 7 illustrates a flowchart of an example method for utilizing video identification coding related to provisioning online multimedia services, in other aspects.

FIGS. 8 and 9 depict a flowchart of a sample method for authorizing a television user based on video identification coding, according to further aspects.

FIG. 10 illustrates a flowchart of a sample method for provisioning multimedia content services, according to particular aspects.

FIGS. 11 and 12 illustrate a flowchart of an example method for utilizing video identification coding for user authorization, in one or more aspects.

FIG. 13 illustrates a block diagram of an example electronic computing environment that can be implemented in conjunction with one or more aspects.

FIG. 14 depicts a block diagram of an example data communication network that can be operable in conjunction with various aspects described herein.

### DETAILED DESCRIPTION

The disclosed subject matter is described with reference to the drawings, wherein like reference numerals are used to refer to like elements throughout the description. In the following description, for purposes of explanation, numerous specific details are set forth in order to provide a thorough understanding of the subject innovation. It may be evident, however, that the disclosed subject matter may be practiced without these specific details. In other instances, well-known structures and devices are shown in block diagram or schematic form in order to facilitate describing the subject innovation.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “module”, “interface,” “user interface”, and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

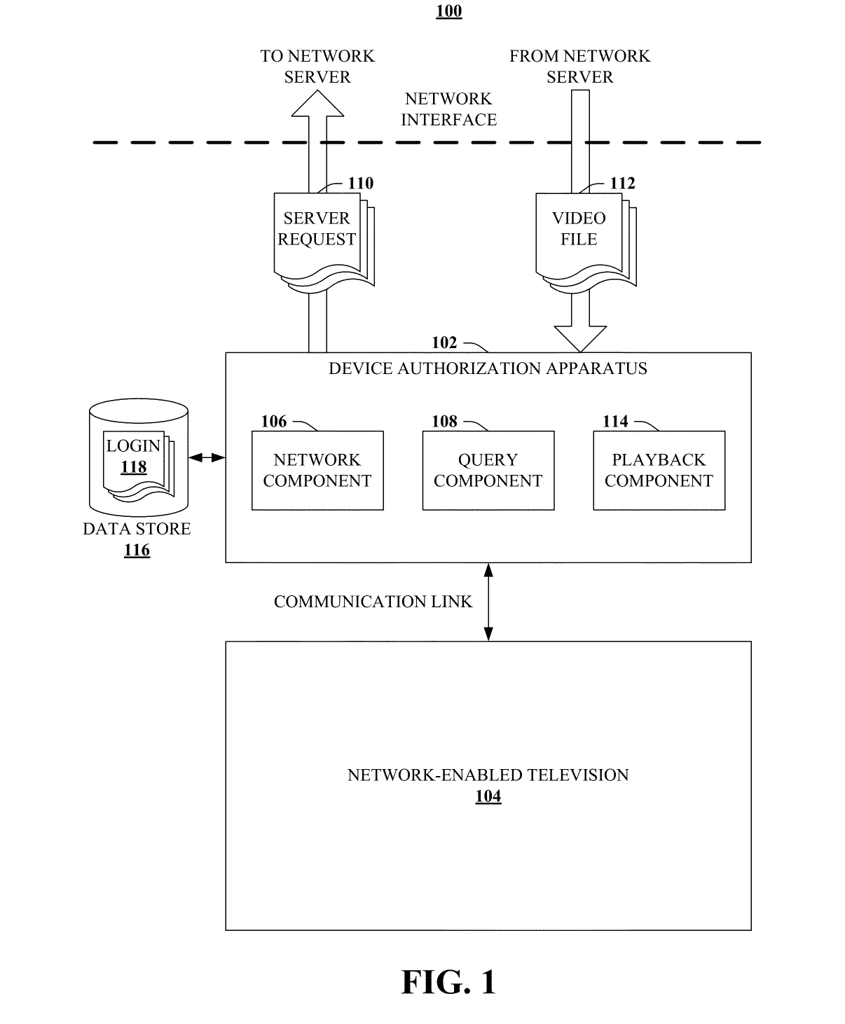

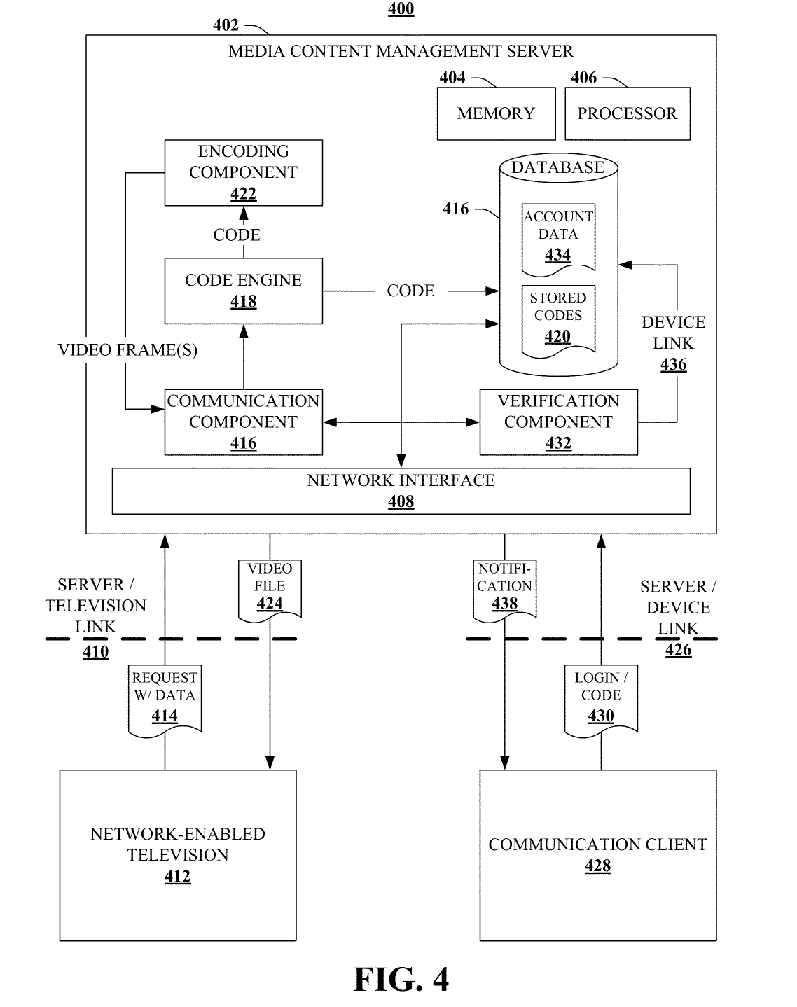

FIG. 1 illustrates a block diagram of an example system 100 for facilitating user authorization related to online multimedia content television services, according to one or more aspects of the subject disclosure. As will be described in more detail below, system 100 can serve as a client within a client-server communication related to user authorization. Particularly, system 100 can be configured to request and receive an identification code (e.g., a personal identification code, or PIN) from a server (not depicted, but see FIG. 4, infra, for instance) and display the identification code for a user of system 100. In various disclosed aspects, the identification code can be a video file displayed on a video display for viewing by a user or viewer of system 100.

System 100 can comprise a device authorization apparatus 102 communicatively connected to a network-enabled television 104. As utilized herein, a network-enabled television is an electronic device capable at least of playing television content, and in some aspects other content (e.g., audio content, text content, message content, webpage content, . . . ), and having an interface configured to transmit and receive data on a data network. Such an interface can include an Internet Protocol (IP)-based wired or wireless interface, although the subject disclosure is not limited to IP-based communication protocols. In example implementation, it is anticipated that because the network-enabled television is able to transmit and receive data on the data network, the network-enabled television can request content available at a particular network location (e.g., stored on a data store and accessed by a data server), make a content selection, and receive the content for viewing. However, the definition of network-enabled television is not limited to this particular example and other instances of a network-enabled television transmitting and receiving data for playback/viewing are within the scope of the subject disclosure. In regard to receiving media content for playback, both streaming download and full file download are anticipated as part of receiving content for viewing, although other platforms for transferring multimedia content known to a person of ordinary skill in the art or made known to such person by way of the context provided herein are considered within the scope of the subject disclosure.

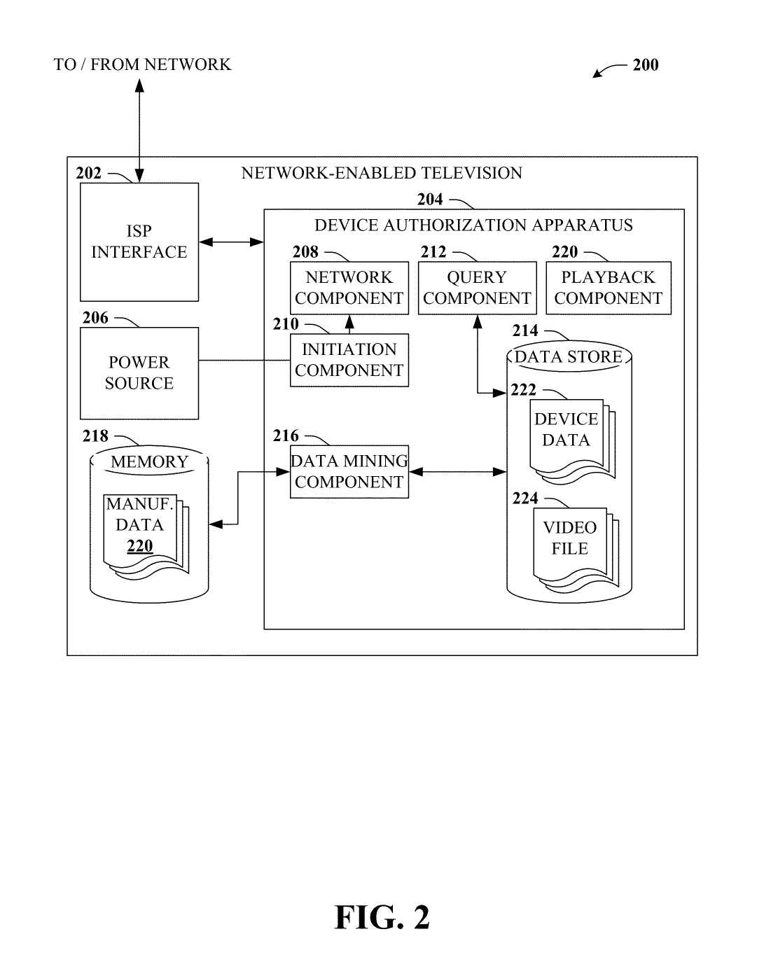

In one aspect, device authorization apparatus 102 can be physically co-located with network-enabled television 104, for instance residing within a housing or enclosure of network-enabled television 104, or the like (e.g., see FIG. 2, infra). In another aspect, device authorization apparatus 102 can be physically external to network-enabled television 104, and communicatively connected via a suitable wired or wireless electronic communication link. In this aspect, which is depicted by FIG. 1, a suitable wired electronic communication link can comprise a universal serial bus (USB) communication cable, a high definition multimedia input (HDMI) communication cable, a coaxial cable, or other suitable electronic or data signaling cable, or a suitable combination thereof. A wireless electronic communication link can comprise, for instance, a Wi-Fi link, an infrared wireless data link, a wireless local area network (e.g., mediated by a wireless router) or wireless personal area network (e.g., wireless USB), or the like, or a suitable combination thereof.

Device authorization apparatus 102 can comprise a network component 106 configured to initiate a communication with a network server associated with multimedia television content. The communication can be conducted over an electronic communication network (not depicted). Network component 106 can be configured for communication over one or more predetermined networks (e.g., an Internet Protocol network, a mobile telecommunication network(s), a telephone network, . . . ) and can store rules or protocols for implementing such communication(s), or can access the rules or protocols stored at a separate entity (e.g., data store 116).

Device authorization apparatus 102 can further comprise a query component 108 configured to send a request 110 for a video verification file 112 to the network server. The video verification file 112 can be encrypted, in some aspects, to mitigate unauthorized access to the video verification file, or can be unencrypted in other aspects (e.g., where the communication with network server is a secure communication, an encrypted communication, or where encryption is not desired). Request 110 can be transmitted over the communication with the network server established by network component 106.

In one aspect of the subject disclosure, the video verification file 112 can comprise video-encoded data. The video-encoded data can comprise a personal identification code. This personal identification code can, for instance, be generated as a picture and converted into a video file format to yield the video-encoded data. The personal identification code can be any suitable sequence of characters. In a particular aspect, request 110 can specify, or include data specifying, a language for the video PIN. In such case, alphabetic characters of the sequence of characters can be derived from an alphabet associated with the language (e.g., Latin alphabet, Cyrillic alphabet, . . . ).

In further aspects, the sequence of characters can be derived from symbols included with a remote control operating device associated with network-enabled television 104. For instance, the sequence of characters can comprise symbols related to audio/video playback keys, channel selection keys, television function keys, or the like, or a suitable combination thereof. In this case, the sequence of characters can be constructed to be easy to enter with a typical human interface device employed for the network-enabled television 104 (e.g., the remote control operating device). This can provide significant utility, by reducing difficulty of entering alphanumeric characters on a human interface device associated with network-enabled television 104 that does not comprise a full alphanumeric keyboard.

In one aspect, video verification file 112 can be received at network component 106 directly in response to request 110, and provided to a playback component 114. In an alternative aspect, however, a response to request 110 can provide a link (e.g., universal resource locator, or URL, or other suitable network link) to the video verification file. In the latter alternative, network component 114 can be configured to acquire the video verification file from the link.

Playback component 114 can be configured to play the set of video-encoded data on the network-enabled television 104. In one aspect, playback component 114 can display a notice that verification file has been received and is ready for display, before playing the set of video-encoded data. In this aspect, playing the set of video-encoded data can be in response to a command by a user of network-enabled television 104 (e.g., pressing a play button). In other aspects, playback component 114 can be configured to play the set of video-encoded data in response to receiving and processing video verification file 112.

FIG. 2 illustrates a block diagram of an example network-enabled television 200 according to further aspects of the subject disclosure. Network-enabled television 200 can comprise, for example, an Internet Protocol capable television (IPTV), an Internet ready television, or the like. Although not depicted, network-enabled television 200 can be communicatively connected to a wired or wireless network for connecting to the Internet. To this end, network-enabled television 200 can comprise an Internet service protocol (ISP) interface 202, in some disclosed aspects, particularly where network-enabled television 200 is communicatively connected directly to an IP network. In other aspects, ISP interface 202 can alternatively comprise or consist of a mobile network interface configured to communicate wirelessly with one or more terrestrial radio access networks that can facilitate Internet access (e.g., global system for mobile communication [GSM], code division multiple access [CDMA], wideband CDMA, high speed packet access [HSPA], third generation partnership project [3GPP] long term evolution [LTE], wireless interoperability for microwave access [WiMax], . . . ) in addition to, or instead of a direct connection to the IP network.

Utilizing the IP connection or IP access provided by ISP interface 202, a device authorization apparatus 204 can acquire user verification information related to acquiring online multimedia content over ISP interface 202 for display on network-enabled television 200. The user verification information can be configured, for instance, to differentiate between an actual person using/viewing network-enabled television 200 and an entity that is not a person attempting to access online multimedia content (e.g., a computer, or bot program, . . . ). To this end the user verification information can be a code configured to be displayed on a display screen of network-enabled television 200. A code embedded in a video file can often be very difficult for a computer or bot program to interpret, since proper interpretation of the code could require actual viewing of the code that is displayed on the screen. In turn, acquiring access to online multimedia content can be conditioned on successful return or entry of the code, thereby limiting access to the online content to persons viewing the code displayed on the display screen.

In a particular aspect of the subject disclosure, device authorization apparatus 204 can comprise an initiation component 210 configured to trigger activation of device authorization apparatus 204 in response to detecting a power-on event at network-enabled television 200. Initiation component 210 can be connected to a power source 206 of network-enabled television 200, and can be configured to identify and interpret the power-on event by monitoring power signals of power source 206. Once the power signals satisfy a suitable power-on condition, initiation component 210 can trigger the activation of device authorization component 204. In response to this trigger, network component 208 can employ ISP interface 202 to communicate with the Internet, and a network server(s) associated with user authorization for online multimedia content. In one aspect, the network address(es) of such a network server(s) can be stored in memory (e.g., data store 214), and retrieved and employed to initiate the communication in response to the trigger. In other aspects, network component 208 can respond to the trigger by retrieving from memory and displaying information pertaining to one or more user authorization servers. A user selection (e.g., input on a remote control of network-enabled television 200, or input by other human machine interface mechanism associated with network-enabled television 200) can be received to identify a selected user authorization server, and communication with such server can be initiated by network component 208 as described hereinabove.

Device authorization apparatus 204 can further comprise a query component 212 that sends a request to a (selected) network server related to user authorization for online multimedia content. The request can include, in some disclosed aspects, information pertaining to network-enabled television 200 stored in a data store 214. For instance, in a particular aspect, network-enabled television 200 can comprise a data mining component 216. Data mining component can be configured to search a memory 218 of network-enabled television 200 for identifying information stored in a manufacturer's data file 220 pertaining to network-enabled television 200. Alternatively, data mining component 216 can initiate a communication with a memory controller (not depicted) or other communication apparatus of network-enabled television 200, and request and receive in response, the identifying information. Such identifying information can include, but is not limited to, information indicative of a technical specification of network-enabled television 200, information indicative of a manufacturer of network-enabled television 200, information indicative of a model of network-enabled television 200, information indicative of a serial number of network-enabled television 200, or the like, or a suitable combination thereof. The identifying information acquired by data mining component 216 can be stored in a device data file 222 of data store 214. This information can be retrieved by query component 212, and at least a subset of such information included with the request related to user authorization for online multimedia content. This information can be employed, in at least one aspect, to link network-enabled television 200 with a user account, subscriber account, . . . , etc., for the online multimedia content, as is described in more detail hereinbelow.

In response to the request transmitted by query component 212, network-enabled television can receive a video verification file (or link to such file). The video verification file can be stored by network component 208 in video file 224 of data store 214. Playback component 220 can retrieve the stored video verification file from video file 224, and play the video verification file on a display of network-enabled television 200, as described herein.

Network-enabled television 200 has some particular advantages worth noting. First, network-enabled television 200 is integrated with device authorization apparatus 204, and thus a user need not acquire a separate device authorization apparatus to connect to network-enabled television 200 in conjunction with user authorization related to acquiring online multimedia content. In addition, network-enabled television 200 and device authorization apparatus can presumably be configured by a manufacturer or assembler to provide pre-configured communication between data mining component 216 and memory 218 for reliable access to manufacturer data file 220. Alternatively, manufacturer data file 220 might be pre-loaded onto device data file 222 in one aspect, or in yet another alternative aspect, query component might be pre-configured with the information stored in manufacturer data file 220, or pre-configured with access to such information, obviating a need for data mining component 216 or device data 222, or both, in one or more of these alternative aspects. Thus, network-enabled television 200 provides a more turn-key solution to complying with user authorization requirements and obtaining access to, and ultimately viewing, online multimedia content.

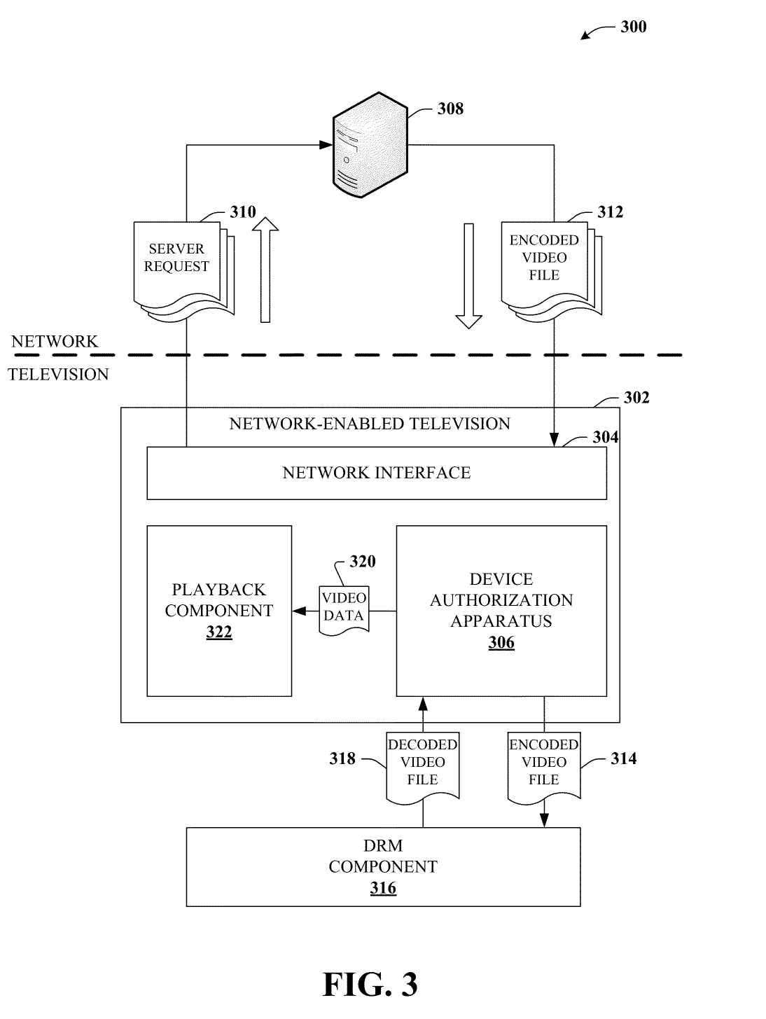

FIG. 3 depicts a block diagram of an example client-server communication environment 300 related to online multimedia content for network television, according to additional aspects disclosed herein. Client-server communication environment 300 can comprise a network-enabled television 302 configured to communicate with a network server 308 via a network interface 304. Utilizing this communication, a device authorization apparatus 306 can submit a server request 310 to network server 308. As described herein, the network request 310 can comprise a request for a video authorization file, and can further include identifying information pertaining to network-enabled television 302, to facilitate network server 308 linking network-enabled television 302 with a subscriber account related to online multimedia content, as is described in more detail hereinbelow.

In response to server request 310, network server 308 can transmit a response comprising an encoded video file 312. In at least one aspect, encoded video file 312 can be encoded according to a digital rights management (DRM) encoding protocol. Device authorization apparatus 306 can receive the response over network interface 304, extract encoded video file 312 from the response and output an extracted encoded video file to a DRM component 316 for decoding. DRM component 316 is depicted as separate from network-enabled television 302 and device authorization apparatus 306. However, the subject disclosure need not be implemented as depicted. In an alternative aspect, DRM component 316 can be included within network-enabled television. In another alternative aspect, both device authorization apparatus 306 and DRM component 316 can be separate from network-enabled television 302. Where device authorization apparatus 306 or DRM component 316 are separate from each other or from network-enabled television 302, data communication among such devices can be conducted via a suitable means of data communication, whether wired or wireless, such as a USB cable, HDMI cable, Wi-Fi link, Bluetooth link, or the like, or a suitable combination thereof.

Upon receiving extracted encoded video file 314, DRM component 316 can attempt to decode the DRM encoding. To implement the decoding, DRM component 316 can store a set of DRM protocols, and analyze data within extracted encoded video file 314 to identify a type of DRM protocol employed for the DRM encoding of extracted encoded video file 314. If the type of DRM protocol is successfully identified, DRM component 316 decodes the video file and outputs a decoded video file 318 to device authorization apparatus 306. Otherwise, if a type of DRM protocol cannot be determined, or the decoding fails, DRM component outputs a decoding error (not depicted) to device authorization apparatus 306 instead.

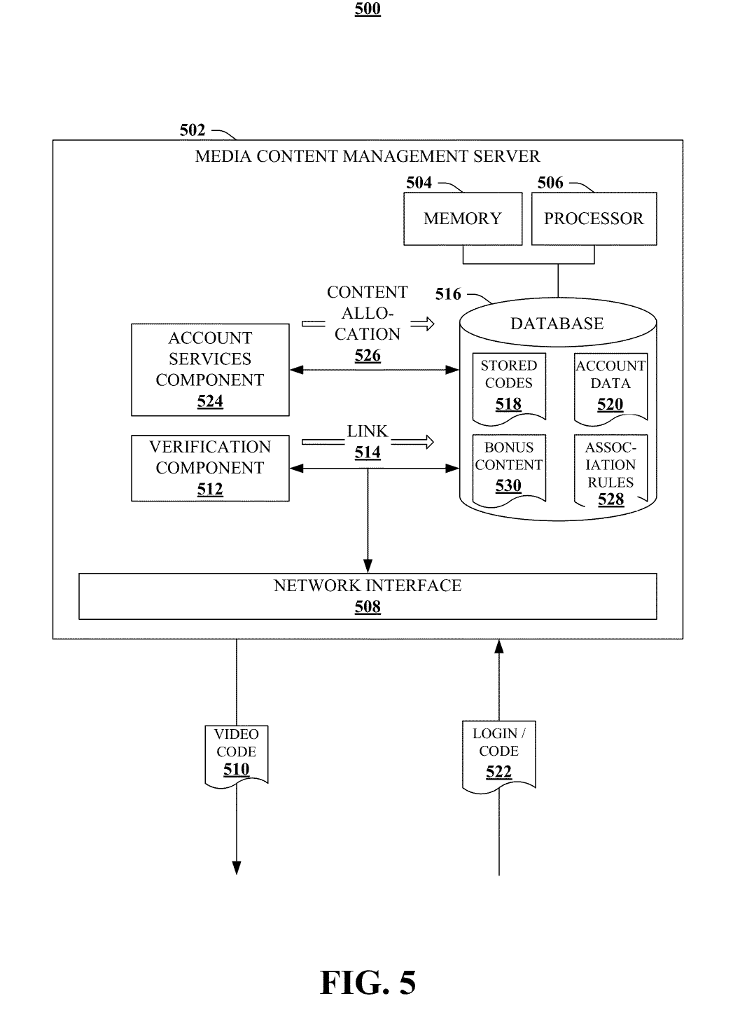

In the event that decoded video file 318 is received by device authorization apparatus 306, device authorization apparatus 306 can provide a video data file 320 comprising a set of video data generated by network server 308 to a playback component 322. Playback component 322 can then play the set of video data on a video display of network-enabled television 302, enabling a viewer/user of network-enabled television 302 to view an identification code contained within the set of video data. This identification code can be submitted by the viewer/user to network server 308 in conjunction with a subscriber login to verify the viewer/user is a person, and optionally link a subscriber account associated with the subscriber login to the information identifying network-enabled television 302 (e.g., see FIGS. 4 and 5, infra).

In the event that DRM component 316 outputs the decoding error to device authorization apparatus 306, device authorization apparatus 306 can include a video message specifying a DRM decoding error within video data file 320. Playback component 322 can receive video data file 320, and play the DRM decoding error on the video display of network-enabled television 302. Alternatively, in the event that DRM component 316 is not properly connected to network-enabled television 302 or device authorization apparatus 306, device authorization apparatus 306 can, upon failing to extract the set of video data from encoded video file 312, send the DRM decoding error to playback component 322 as well. Thus, where DRM component is not available or is unable to properly decode extracted encoded video file 314, the DRM decoding error is played on the video display to inform a user of the failure to implement the DRM decoding.

FIG. 4 illustrates a block diagram of an example network system 400 according to additional aspects of the subject disclosure. As depicted, network system 400 can comprise a media content management server 402 configured to utilize video coding in conjunction with authorizing user access to online multimedia content. Media content management server 402 can comprise a memory 404 for storing computer-executable components, and a processor 406 communicatively connected to memory 404. Processor 406 can be configured to facilitate execution of one or more of the computer-executable components stored in memory 404. In some aspects, the computer-executable components can comprise one or more components of media content management server 402, which can partially or wholly be stored in memory 404. In other aspects, components of media content management server 402 can be separate from memory 404, while a subset of data or protocols associated with these components can comprise the computer-executable components stored in memory 404.

As depicted, media content management server 402 can comprise a network interface 408 configured to send and receive data over a data network, such as the Internet, an intranet, or the like. Utilizing the data network as a communication intermediary, media content management server 402 can form a communication link 410 with a network-enabled television 412 (communication link 410 can also be referred to as a server-television link 410), and can transmit data to, and receive data from, network-enabled television 412. Particularly, media content management server 402 can receive a request 414 for a video verification file, as described herein. Request 414 can be embedded with identifying information pertaining to network-enabled television 412. This identifying information can comprise information pertaining to technical specifications, a manufacturer, model, serial number, or the like, pertinent to network-enabled television 412.

A communication component 416 can be configured to receive request 414 for a verification code via network interface 408. In particular aspects, communication component 416 can be configured to extract identifying information pertaining to network-enabled television 412 from request 414. In response to receiving request 414, a code engine 418 can be triggered to generate a distinct verification code for the request. In at least one aspect, the distinct verification code can be particular to request 414. For instance, the distinct verification code can be generated at least in part from information pertaining to request 414 (e.g., network address of network-enabled television), or can be generated from information included in the request (e.g., a subset of the identifying information pertaining to network-enabled television 402). The subject disclosure is not limited to these aspects, however; in other aspects the distinct verification code can be generated from an algorithm independent of request 414.

Code engine 418 can store the distinct verification code in a database 416 at a stored codes file 420. Code engine 418 further provides the distinct verification code to an encoding component 422. Encoding component 422 can be configured to create the distinct verification code as a picture. The picture can have any suitable digital picture format, as is known in the art, for displaying the distinct verification code graphically. Moreover, encoding component 422 can be further configured to convert the picture of the distinct verification code into a set of video frames. Encoding component 422 can provide the set of video frames to communication component 416. Communication component 416 can transmit a video file response 424 comprising the set of video frames to network-enabled television.

Media content management server 402 can be further configured to a service-client link 426 with a communication client 428. In at least one aspect, server-client link 426 can comprise a network communication platform such as a webpage. Communication client 428 can be employed by a user/viewer of network-enabled television 412 to submit a subscriber login 430. Communication client can be a computer, laptop computer, mobile phone, personal digital assistant, tablet computer, or the like, configured to communicate over a network with media content management server 402. Subscriber login 430 will generally include login information (e.g., a username and password, . . . ) for client login to a subscriber account pertaining to online multimedia services. Additionally, subscriber login 430 can include data indicative of the distinct verification code transmitted within video file 424 by communication component 416.

Upon receiving subscriber login 430 at network interface 408, a verification component 432 can be configured to extract the data included within subscriber login 430 and reference account data file 434 of database 416 to determine whether the login information matches login information of a subscriber account stored in account data file 434. If the login data matches login information of a subscriber account, verification component 432 can authorize access to subscriber account information for communication client 428. Additionally, verification component 432 can be configured to extract the data indicative of the distinct verification code from subscriber login 430, and determine whether the data matches a code stored in stored code file 420. If the data does indeed match a stored code, verification component can be further configured to link the identifying information pertaining to network-enabled television 412 received in request 414 with the subscriber account, in account data file 434.

In at least one aspect of the subject disclosure, media content management server 402 can be configured to allocate additional multimedia services, content, or the like to the subscriber account in response to linking the identifying information pertaining to network-enabled television 412 with the subscriber account. The services, content, etc., can be based on technical capabilities of network-enabled television 412 (e.g., high definition content in the event that network-enabled television 412 is a high definition television), content provider promotional offers, and so on. Allocation of additional services, content, etc., is discussed in more detail at FIG. 5, infra.

FIG. 5 illustrates a block diagram of an example system 500 comprising a media content management server 502 according to additional aspects of the subject disclosure. In at least one aspect, media content management server 502 can be similar to media content management server 402 of FIG. 4, supra, sharing some or all features thereof. The subject disclosure is not so limited, however, and it should be appreciated that media content management server 502 can have a subset of shared features or no shared features in other aspects, and likewise media content management server 402 can have a subset of features of media content management server 502, or no shared features.

Media content management server 502 can comprise a memory 504 for storing computer-executable components, and a processor 506 communicatively connected to memory 504. Processor 506 can be configured to facilitate execution of one or more of the computer-executable components stored in memory 504. In some aspects, the computer-executable components can comprise one or more components of media content management server 502, which can partially or wholly be stored in memory 504. In other aspects, such components can be separate from memory 504, while a subset of data or protocols associated with these components can comprise the computer-executable components stored in memory 504.

Media content management server 502 can comprise a network interface 508 for sending and receiving data over a data network. In response to receiving a request for a video verification file on the data network, as described herein, media content management server 502 can transmit a video code file 510 comprising a set of video data containing a distinct verification code. The distinct verification code can be stored in a database 516 at a stored codes file 518, for later reference.

Network interface 508 can also be employed to receive a login attempt 522 from a remote client (not depicted, but see FIG. 4, infra). A verification component 512 can extract account login data from login attempt 522, and match the account login data to information stored in a subscriber account data file 520 of database 516. If such a match exists, verification component 512 can log the remote client into a subscriber account having the matching data.

Verification component 512 can be further configured to identify verification code data within login attempt 522. In the event that login attempt 522 comprises such data, verification component 512 can match the verification code data to one or more distinct verification codes in stored codes file 518. If a match is found, verification component 512 can store a link 514 between a display device (identified, e.g., within the request for the video verification file) and the subscriber account, within the account data file 520.

As an alternative to the foregoing, upon logging the remote client into the subscriber account, verification component 512 can be configured to transmit a verification code query (not depicted) to the remote client in response to login attempt 522. This transmission can be performed in response to logging in the subscriber account or determining that login attempt 522 includes no verification code data, for instance. A response from the remote client including the verification code data can be handled as described above, to determine whether a match exists to a distinct verification code within stored codes file 518. Thus, in this alternative, the verification code data need not be included with login attempt 522, but rather can be included in a separate message. This separate message can be sent by the remote client in response to a query sent by verification component 512, or sent without such a query, depending on a configuration of the remote client or media content management server 502.

In additional aspects of the subject disclosure, media content management server 502 can comprise an account services component 524. Account services component 524 can be configured to allocate one or more reserved content services to the subscriber account, in response to linking the display device to the subscriber account. Content allocation 526 can be stored in account data file 520. Content allocation 526 identifies a set of content services or bonus content 530 (e.g., free or reduced cost content, free or reduced cost premium services, . . . ) that can be allocated to the subscriber account. Moreover, the content or services, an amount thereof, duration of allocation, and other specifications are determined by a set of association rules 528 stored in database 516. Particularly, the association rules define what bonus content or services are allocated to the subscriber account, and the conditions for such allocation. Suitable conditions can include characteristics of the display device (e.g., high definition, aspect ratio, screen size, . . . ), characteristics of the subscriber account (e.g., length of active subscription, level of subscription, premium content subscriber, . . . ), or particular provider-defined rules stored in association rules 528. In one example, the one or more reserved content services can be selected from a set of reserved content services at least in part from identifying information pertaining to a display device linked to the subscriber account. In another example, the one or more reserved content services can be selected from the set of reserved content services at least in part based on a number, or a type, of linked communication services connected to the network content user account, stored in account data file 520. Linked communication services can include e-mail service, text message service, mobile phone service, short message service, multimedia message service, social network service (e.g., Facebook, LinkedIn, Twitter, . . . ), or the like, in which content, login information, personal/business contact data, etc., are shared among a subset of the linked communication services and the subscriber account related to online multimedia services. Other examples, known in the art or made known to one of ordinary skill in the art by way of the context provided herein are considered within the scope of the subject disclosure.

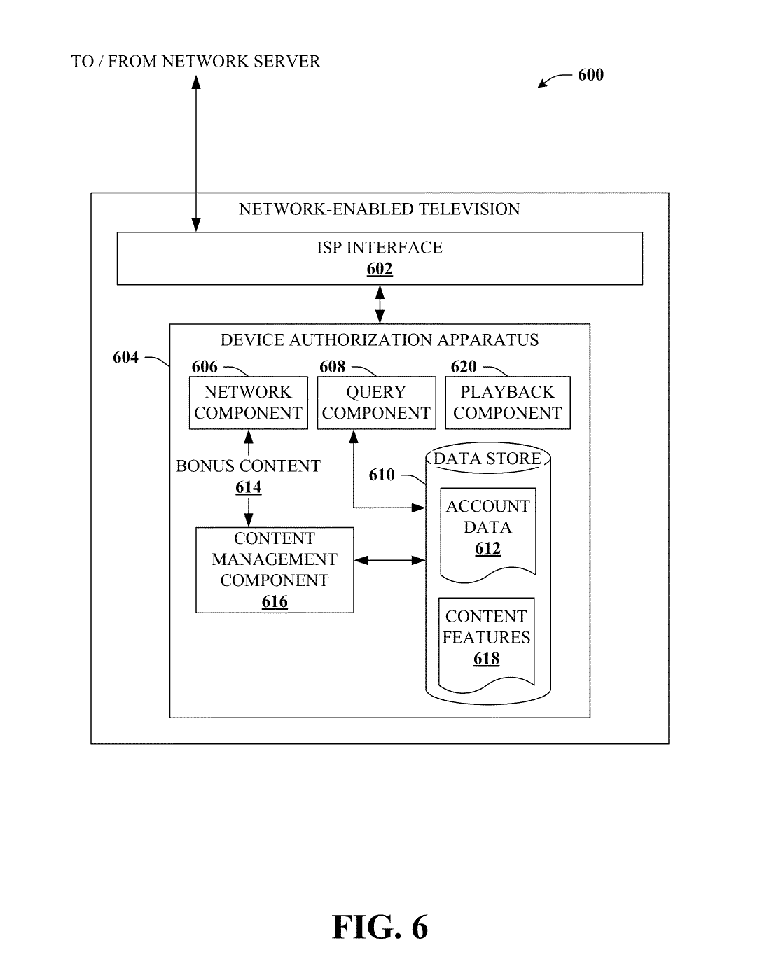

FIG. 6 illustrates a block diagram of an example network-enabled television 600 according to one or more additional aspects of the subject disclosure. Network-enabled television 600 can comprise an Internet service provider (ISP) interface 602. ISP interface 602 can be a suitable Internet connection, such as a cable Internet connection, DSL Internet connection, mobile phone Internet connection, satellite Internet connection, and so on. Additionally, a device authorization apparatus 604 can be communicatively connected to ISP interface 602, enabling a network component 606 to send or receive data over the Internet.

Device authorization component 608 can comprise a query component 608 configured to send a request for a video verification code, and can receive a set of video data in response to the request, which can be stored in a data store 610. A playback component 620 can play the set of video data to display an identification code included therein on a video display of network-enabled television 600. In response to a proper subscriber login specifying the identification code, network-enabled television 600 can receive a set of bonus content 614 provided to network-enabled television 600 as a result of proper specification of the identification code, at ISP interface 602 and network component 606. Bonus content 616 can include content or services that can be consumed by network-enabled television 600, in conjunction with one or more rules for such consumption. Bonus content 616 (and applicable rules) can be provided to a content management component 616. Content management component 616 can store bonus content 614 and such rules in data store 610 in a content features file 618. Additionally, content management component 616 can be configured to apply the bonus content rules in providing access to the content or services provided with t the bonus content 616. For instance, where bonus content 616 includes a set of free videos that can be played on network-enabled television 600, content management component 616 can request access to one or more of the set of free videos consistent with the rules, and can track usage of the set of free videos. Content management component 616 can display a number of the set of free videos remaining for view, decrement the number upon viewing a bonus video at network-enabled television, and display a remaining number consistent with the rules. Thus, content management component 616 can be configured to coordinate consumption of bonus content or bonus services allocated to network-enabled television 600 in response to proper specification of the identification code, consistent with rules for consuming the bonus content or bonus services established by a provider of such content/services.

The aforementioned diagrams have been described with respect to interaction between several systems, apparatuses, components, user interfaces, and display indicators. It should be appreciated that such diagrams can include those components or systems specified therein, some of the specified components, or additional components. For example, a system could include network-enabled television 600 communicatively connected to media content management server 502 over a suitable network connection. Sub-components could also be implemented as components electrically connected to other sub-components rather than included within a parent component. Additionally, it should be noted that two or more components could be combined into a single component providing aggregate functionality. For instance, network component 106 can include query component 108 to facilitate forming a network communication and sending a request for a video verification code, by way of a single component. Components of the disclosed systems and apparatuses can also interact with one or more other components not specifically described herein but known by those of skill in the art, or made known to one of skill in the art by way of the context provided herein.

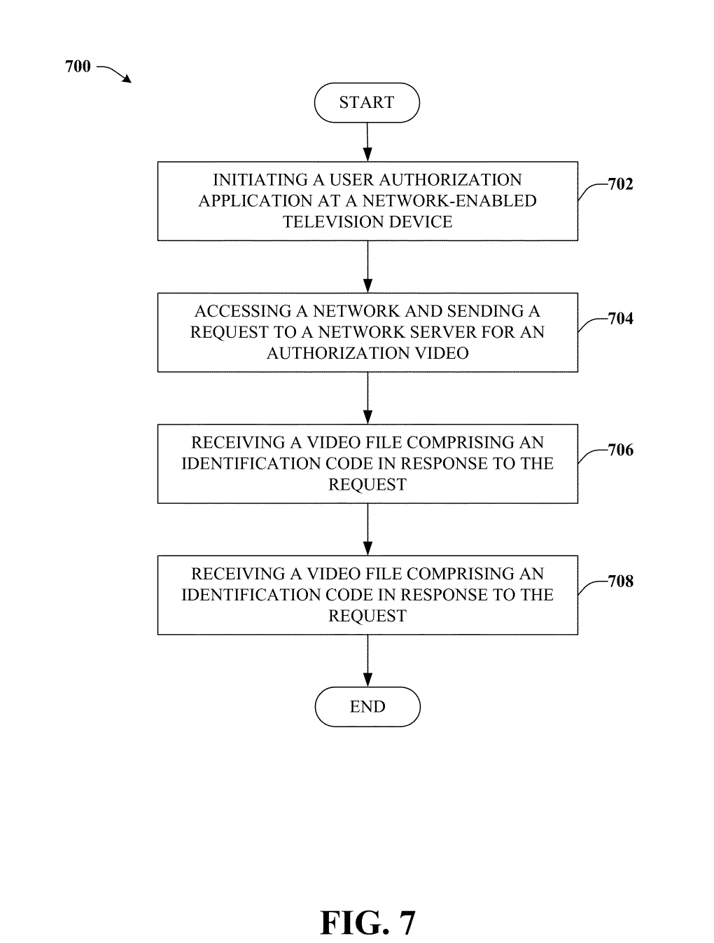

In view of the exemplary diagrams described supra, process methods that may be implemented in accordance with the disclosed subject matter will be better appreciated with reference to the flow chart of FIGS. 7-12. While for purposes of simplicity of explanation, the methods are shown and described as a series of blocks, it is to be understood and appreciated that the disclosed subject matter is not limited by the order of the blocks, as some blocks may occur in different orders and/or concurrently with other blocks from what is depicted and described herein. Moreover, not all illustrated blocks may be required to implement the methods described hereinafter. Additionally, it should be further appreciated that the methods disclosed hereinafter and throughout this specification are capable of being stored on an article of manufacture to facilitate transporting and transferring such methods to an electronic device. The term article of manufacture, as used, is intended to encompass a computer program accessible from any computer-readable device, device in conjunction with a carrier, or storage medium.

FIG. 7 illustrates a flowchart of an example method 700 for providing user authorization in conjunction with providing online multimedia television content, according to additional aspects of the subject disclosure. At 702, method 700 can comprise initiating an application on a television device, where the application is related to facilitating authorization of a user of the television device to receive network media content on the television device. At 704, method 700 can comprise accessing a communication network in response to the initializing the application and sending a request to a network server for an authorization video. At 706, method 700 can comprise receiving a video file in response to the request, where the video file can comprise an identification code rendered in the form of the video file. At 708, method 700 can comprise playing the video file on the television device to facilitate user submission of the identification code as a response to the network server. Method 700 can be employed, for instance, to verify that a user or viewer of the television device is a person, rather than a computer or software bot device. The verification can be valuable to a content service provider desiring to provide subscription-based content to television subscription viewers.

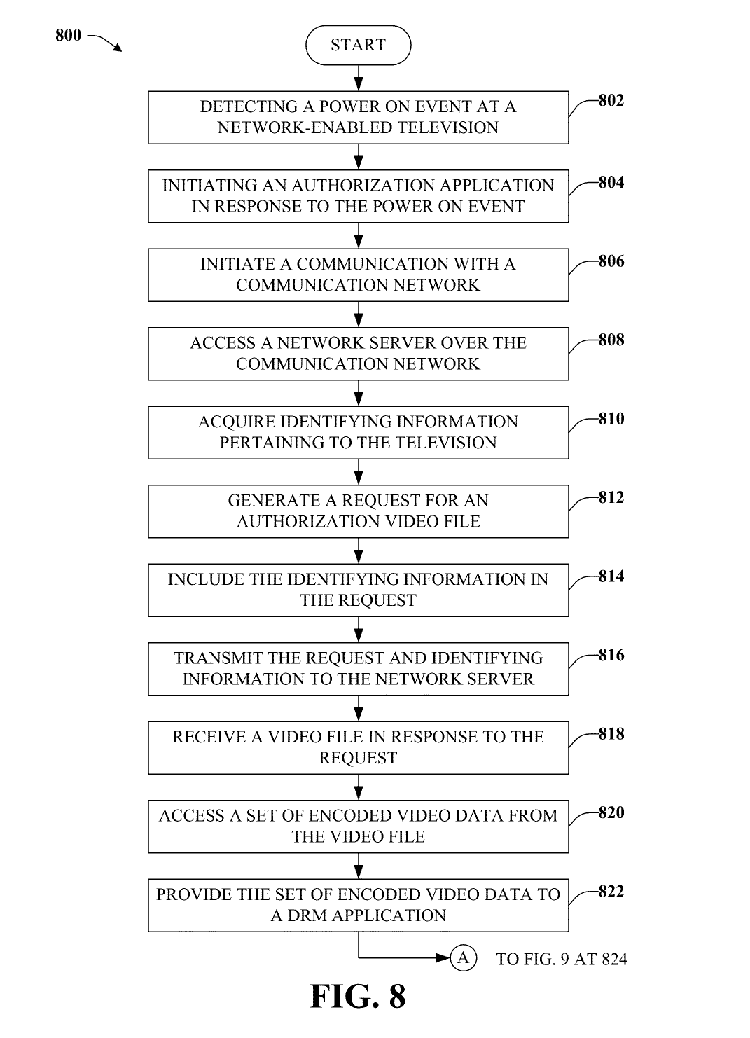

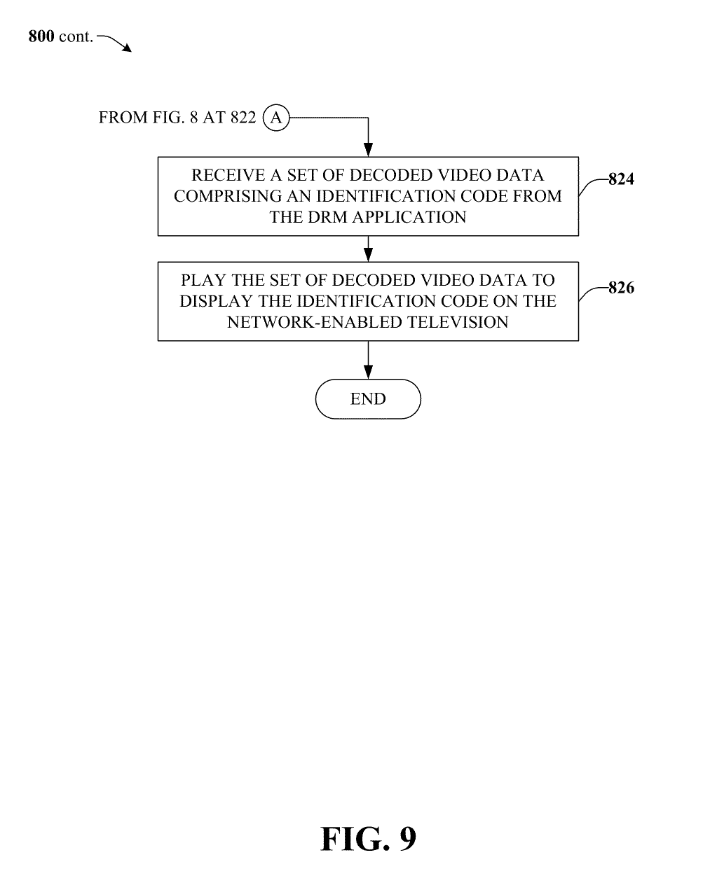

FIGS. 8 and 9 illustrate a flowchart of an example method 800 for providing online multimedia television content according to one or more aspects of the subject disclosure. At 802, method 800 can comprise detecting a power-on event at a network-enabled television device. At 804, method 800 can comprise initiating an authorization application in response to the power-on event. At 806, method 800 can comprise initiating a communication with a communication network at least in part utilizing the authorization application. At 808, method 800 can comprise accessing a network server over the communication network. The network server can be accessed utilizing a server address stored for use by the authorization application.

At 810, method 800 can comprise acquiring identifying information pertaining to the network-enabled television device. The identifying information can include, for instance, a technical specification(s), a model code, a serial number, or a manufacturer code, or the like, or a suitable combination thereof. At 812, method 800 can comprise generating a request for an authorization video file. At 814, method 800 can comprise including the identifying information in the request. At 816, method 800 can comprise transmitting the request and identifying information to the network server.

At 818, method 800 continues, and can comprise receiving a video file in response to the request. At 820, method 800 can comprise accessing a set of encoded video data from the video file. At 822, method 800 can comprise providing the set of encoded video data to a DRM application. Method 800 continues at 824 of FIG. 9.

Referring now to FIG. 9, at 824, method 800 can comprise receiving a set of decoded video data comprising an identification code from the DRM application. At 826, method 800 can comprise playing the set of decoded video data to display the identification code on a video display of the network-enabled television device. Upon playing the set of decoded video data, method 800 can end.

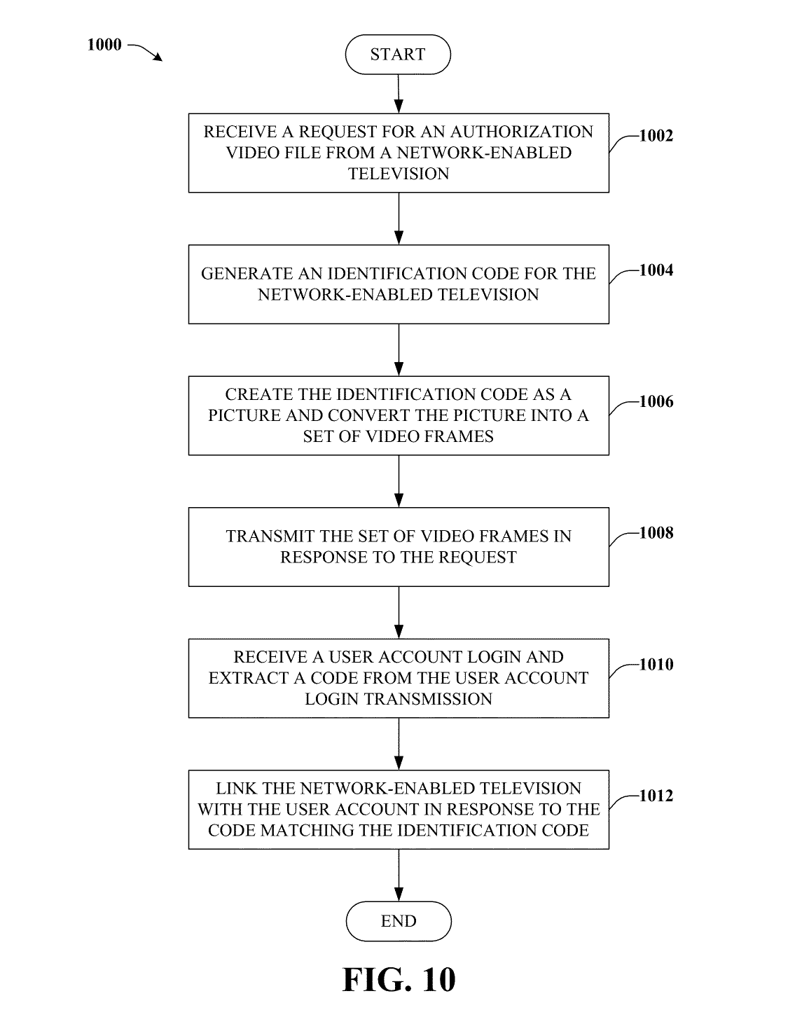

FIG. 10 illustrates a flowchart of an example method 1000 for providing online multimedia television content according to additional disclosed aspects. At 1002, method 1000 can comprise receiving a request for an authorization video file from a network-enabled television device. At 1004, method 1000 can comprise generating an identification code for the network-enabled television device, in response to receiving the request. At 1006, method 1000 can comprise creating the identification code as a picture, and converting the picture into a set of video frames. At 1008, method 1000 can comprise transmitting the set of video frames in response to the request. At 1010, method 1000 can comprise receiving a user account login and extract a code from the user account login transmission. At 1012, method 1000 can comprise linking the network-enabled television device with the user account in response to the code matching the identification code.

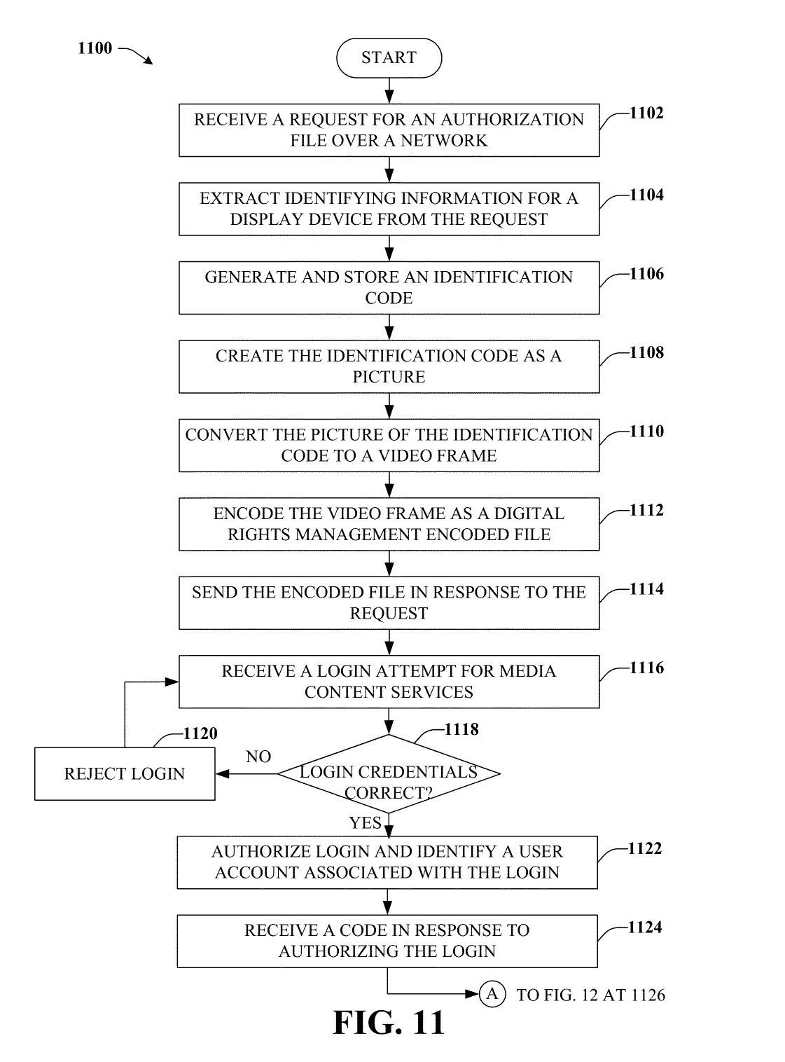

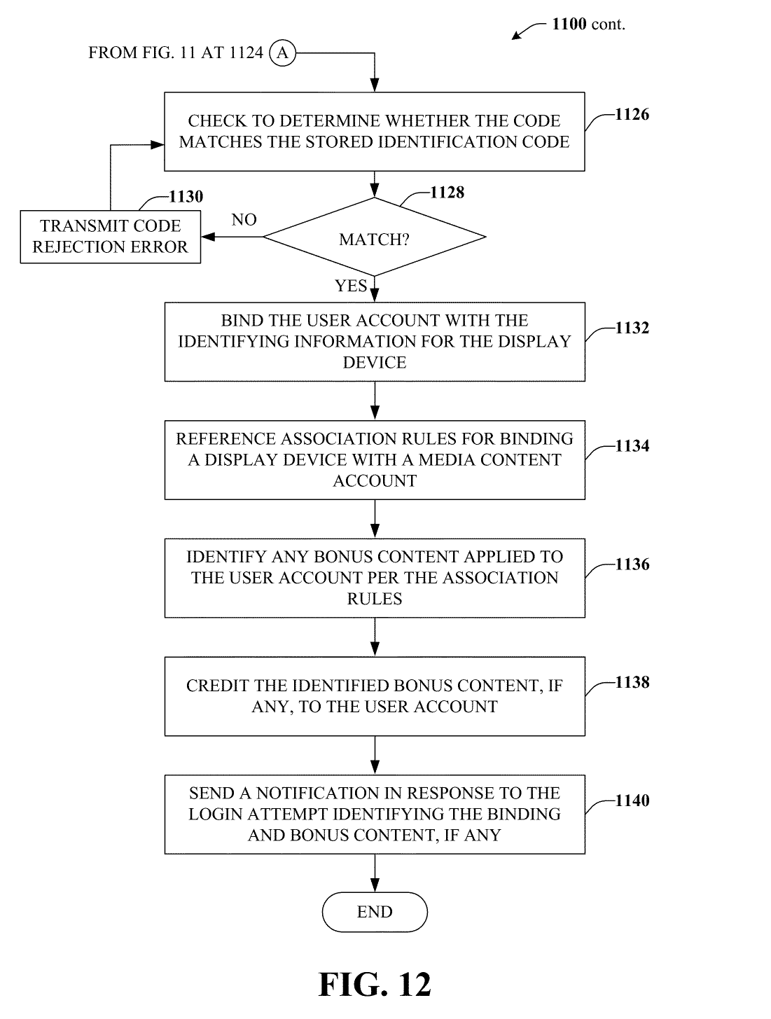

FIGS. 11 and 12 depict a flowchart of a sample method 1100 for verifying user access and providing bonus content or services pertaining to online multimedia television content, according to still other aspects of the subject disclosure. At 1102, method 1100 can comprise receiving a request for an authorization file over a data network. At 1104, method 1100 can comprise extracting identifying information for a display device from the request.

At 1106, method 1100 can comprise generating and storing an identification code. At 1108, method 1100 can comprise creating the identification code as a picture. At 1110, method 1100 can comprise converting the picture of the identification code to a video frame(s). At 1112, method 1100 can comprise encoding the video frame(s) as a DRM encoded file. The encoding can be according to a suitable DRM encoding protocol, as is known in the art. At 1114, method 1100 can comprise transmitting the DRM encoded file in response to the request.

At 1116, method 1100 can comprise receiving a login attempt for a subscriber account associated with online multimedia television services. At 1118, a determination is made as to whether login credentials received in conjunction with the login attempt correctly match stored login credentials for stored subscriber accounts associated with the online multimedia television services. If the login credentials do not correctly match the stored login credentials, method 1100 can proceed to 1120, where method 1100 can comprise rejecting the login attempt, and return to reference number 1116. Otherwise, if the login credentials do correctly match the stored login credentials, method 1100 can proceed to 1122.

At 1122, method 1100 can comprise identifying a subscriber account matching the correctly matching login credentials, and authorizing login to the matching subscriber account. At 1124, method 1100 can comprise receiving a code. The code can be extracted from the login attempt, in one aspect of the subject disclosure, or can be received in a separate transmission from the login attempt following authorizing the login to the matching subscriber account, in other aspects. From 1124, method 1100 can proceed to 1126 at FIG. 12.

Referring now to FIG. 12, method 1100, at 1126, can comprise checking whether the received code matches the stored identification code. At 1128, method 1000 can determine whether a match between the received code and the stored identification code has been identified. If no match occurs, method 1100 can proceed to 1130 and transmit a code rejection error. Otherwise, if a match occurs, method 1100 can proceed to 1132.

At 1132, method 1100 can comprise binding the matching subscriber account with the identifying information for the display device. At 1134, method 1100 can comprise referencing association rules for binding a display device with a media content account. At 1136, method 1100 can comprise identifying bonus content applied to the matching subscriber account per the association rules. At 1138, method 1100 can comprise crediting the identified bonus content, if any, to the matching subscriber account. At 1140, method 1100 can comprise sending a notification in response to the login attempt identifying the binding and the bonus content, if any.

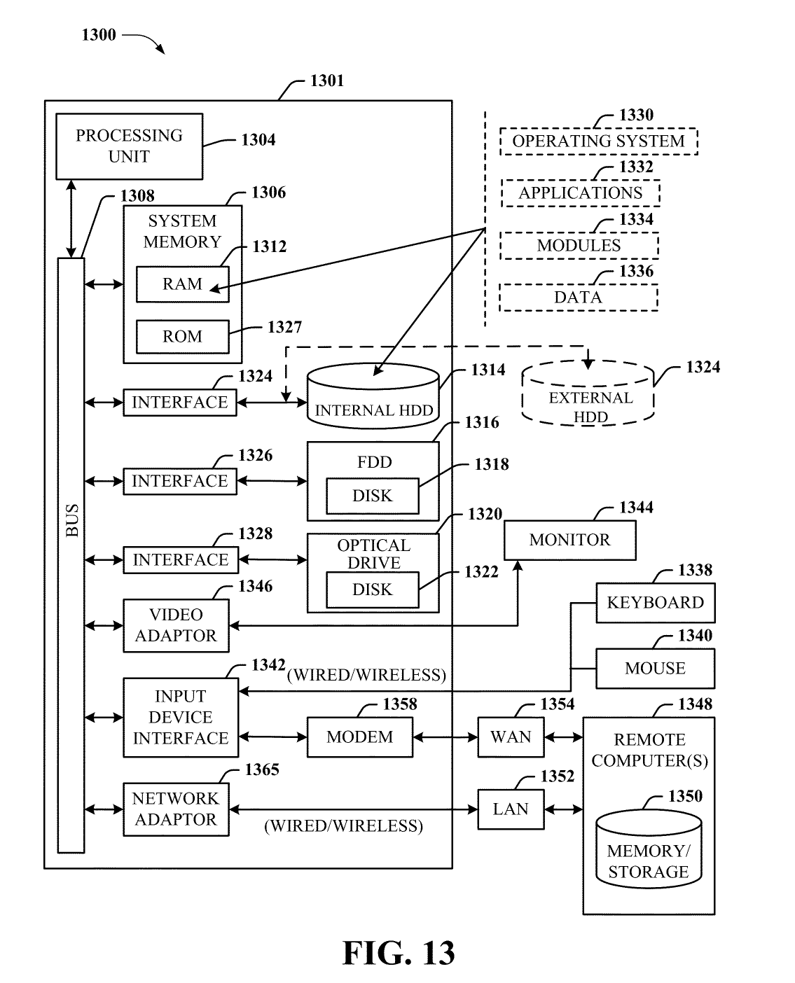

With reference to FIG. 13, an exemplary environment 1300 for implementing various aspects described herein includes a computer 1302, the computer 1302 including a processing unit 1304, a system memory 1306 and a system bus 1308. The system bus 1308 connects system components including, but not limited to, the system memory 1306 to the processing unit 1304. The processing unit 1304 can be any of various commercially available processors. Dual microprocessors and other multi processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes read-only memory (ROM) 1310 and random access memory (RAM) 1312. A basic input/output system (BIOS) is stored in a non-volatile memory 1310 such as ROM, EPROM, EEPROM, which BIOS contains the basic routines that help to transfer information between elements within the computer 1302, such as during start-up. The RAM 1312 can also include a high-speed RAM such as static RAM for caching data.

The computer 1302 further includes an internal hard disk drive (HDD) 1314 (e.g., EIDE, SATA), which internal hard disk drive 1314 can also be configured for external use in a suitable chassis (not shown), a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as the DVD). The hard disk drive 1314, magnetic disk drive 1316 and optical disk drive 1311 can be connected to the system bus 1308 by a hard disk drive interface 1324, a magnetic disk drive interface 1326 and an optical drive interface 1328, respectively. The interface 1324 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1302, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. It is to be appreciated that aspects of the subject disclosure can be implemented with various commercially available operating systems or combinations of operating systems.

A user can enter commands and information into the computer 1302 through one or more wired/wireless input devices, e.g., a keyboard 1338 and a pointing device, such as a mouse 1340. Other input devices (not shown) may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces, such as a parallel port, an IEEE 1394 serial port, a game port, a USB port, an IR interface, etc.

A monitor 1344 or other type of display device is also connected to the system bus 1308 through an interface, such as a video adapter 1346. In addition to the monitor 1344, a computer typically includes other peripheral output devices (not shown), such as speakers, printers, etc.

The computer 1302 can operate in a networked environment using logical connections by wired and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wired/wireless connectivity to a local area network (LAN) 1352 and/or larger networks, e.g., a wide area network (WAN) 1354. Such LAN and WAN networking environments are commonplace in offices and companies, and facilitate enterprise-wide computer networks, such as intranets, all of which may connect to a global communications network, e.g., the Internet.

When used in a LAN networking environment, the computer 1302 is connected to the local network 1352 through a wired and/or wireless communication network interface or adapter 1356. The adapter 1356 may facilitate wired or wireless communication to the LAN 1352, which may also include a wireless access point disposed thereon for communicating with the wireless adapter 1356.

When used in a WAN networking environment, the computer 1302 can include a modem 1358, or can be connected to a communications server on the WAN 1354, or has other means for establishing communications over the WAN 1354, such as by way of the Internet. The modem 1358, which can be internal or external and a wired or wireless device, is connected to the system bus 1308 through the serial port interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi® and Bluetooth™wireless technologies. Thus, the communication can be a predefined structure as with a conventional network or simply an ad hoc communication between at least two devices.

Wi-Fi, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, n, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), or other bands (e.g., 802.11g, 802.11n, . . . ) so the networks can provide real-world performance similar to the basic 10BaseT wired Ethernet networks used in many offices.

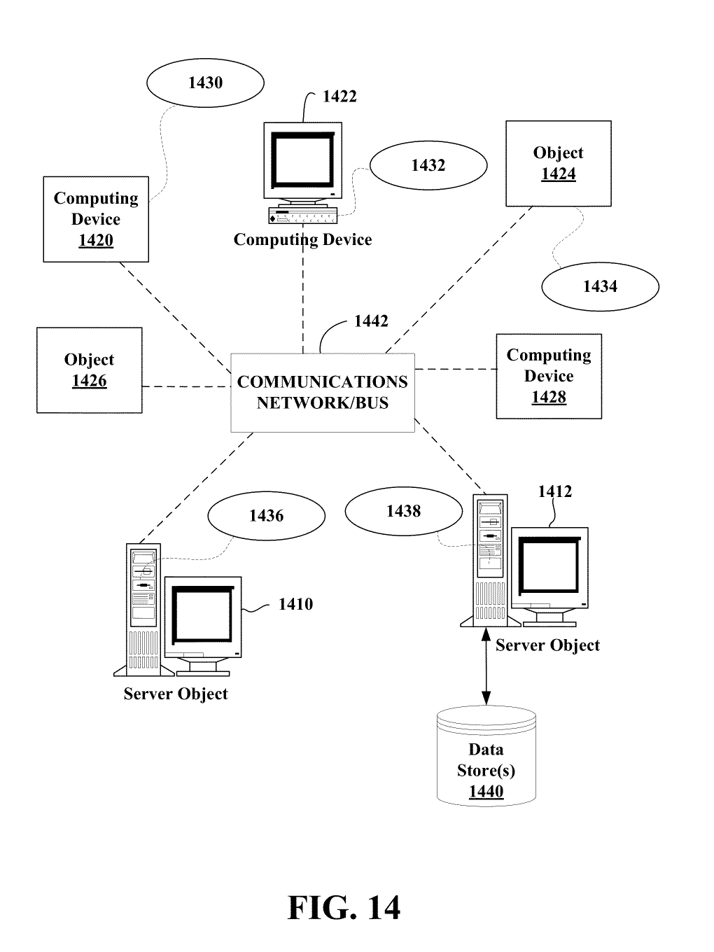

FIG. 14 provides a schematic diagram of an exemplary networked or distributed computing environment. The distributed computing environment comprises computing objects 1410, 1412, etc. and computing objects or devices 1420, 1422, 1424, 1426, 1428, etc., which may include programs, methods, data stores, programmable logic, etc., as represented by applications 1430, 1432, 1434, 1436, 1438 and data store(s) 1440. It can be appreciated that computing objects 1410, 1412, etc. and computing objects or devices 1420, 1422, 1424, 1426, 1428, etc. may comprise different devices, including network-enabled television 104 (FIG. 1), 200 (FIG. 2), 302 (FIG. 3), 600 (FIG. 6), or other devices such as a mobile phone, personal digital assistant (PDA), audio/video device, MP3 players, personal computer, laptop, etc. It should be further appreciated that data store(s) 1440 can include data store 116 (FIG. 1), memory 218, data store 214 (FIG. 2), database 416 (FIG. 4), database 516 (FIG. 5), or data store 610 (FIG. 6).

Each computing object 1410, 1412, etc. and computing objects or devices 1420, 1422, 1424, 1426, 1428, etc. can communicate with one or more other computing objects 1410, 1412, etc. and computing objects or devices 1420, 1422, 1424, 1426, 1428, etc. by way of the communications network 1442, either directly or indirectly. Even though illustrated as a single element in FIG. 14, communications network 1442 may comprise other computing objects and computing devices that provide services to the system of FIG. 14, and/or may represent multiple interconnected networks, which are not shown. Each computing object 1410, 1412, etc. or computing object or devices 1420, 1422, 1424, 1426, 1428, etc. can also contain an application, such as applications 1430, 1432, 1434, 1436, 1438, that might make use of an API, or other object, software, firmware and/or hardware, suitable for communication with or implementation of the techniques for search augmented menu and configuration functions provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems for search augmented menu and configuration functions as described in various embodiments.

Thus, a host of network topologies and network infrastructures, such as client/server, peer-to-peer, or hybrid architectures, can be utilized. One or more of these network topologies can be employed by network-enabled television 104, 200, 302, 600 for communicating with a network. The “client” is a member of a class or group that uses the services of another class or group to which it is not related. A client can be a process, i.e., roughly a set of instructions or tasks, that requests a service provided by another program or process. The client process utilizes the requested service, in some cases without having to “know” any working details about the other program or the service itself.

In a client/server architecture, particularly a networked system, a client is usually a computer that accesses shared network resources provided by another computer, e.g., a server. In the illustration of FIG. 14, as a non-limiting example, computing objects or devices 1420, 1422, 1424, 1426, 1428, etc. can be thought of as clients and computing objects 1410, 1412, etc. can be thought of as servers where computing objects 1410, 1412, etc., acting as servers provide data services, such as receiving data from client computing objects or devices 1420, 1422, 1424, 1426, 1428, etc., storing of data, processing of data, transmitting data to client computing objects or devices 1420, 1422, 1424, 1426, 1428, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1442 or bus is the Internet, for example, the computing objects 1410, 1412, etc. can be Web servers with which other computing objects or devices 1420, 1422, 1424, 1426, 1428, etc. communicate via any of a number of known protocols, such as the hypertext transfer protocol (HTTP). Computing objects 1410, 1412, etc. acting as servers may also serve as clients, e.g., computing objects or devices 1420, 1422, 1424, 1426, 1428, etc., as may be characteristic of a distributed computing environment.

The subject matter described herein can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

The word “exemplary” where used herein means serving as an example, instance, or illustration. For the avoidance of doubt, the subject matter disclosed herein is not limited by such examples. In addition, any aspect or design described herein as “exemplary,” “demonstrative,” or the like, is not necessarily to be construed as preferred or advantageous over other aspects or designs, nor is it meant to preclude equivalent exemplary structures and techniques known to those of ordinary skill in the art.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A system for securing content services at a network-enabled television, comprising:
a network component configured to initiate a communication with a network server associated with the content services over an electronic communication network;
a query component configured to send a request for a video verification file to the network server, the video verification file comprising a set of video-encoded data; and
a playback component configured to obtain the video verification file in response to the request and play the set of video-encoded data on the network-enabled television.

2. The system of claim 1, further comprising a digital rights management (DRM) component configured to verify whether the video verification file is in accordance with a DRM requirement.

3. The system of claim 1, wherein the network component is further configured to receive a transmission from the network server comprising a link to the video verification file.

4. The system of claim 3, further comprising a download component configured to access the link in conjunction with downloading the video verification file and saving the video verification file in a data store associated with the system.

5. The system of claim 1, further comprising a data mining component configured to acquire information pertaining to the network-enabled television and provides the information to the query component for including with the request.

6. The system of claim 5, wherein the information comprises data indicative of a technical specification, a manufacturer, a model, or a serial number of the network-enabled television, or a combination thereof.

7. The system of claim 1, further comprising an initiation component configured to trigger activation of the system in response to detecting a power-on event at the network-enabled television.

8. The system of claim 1, wherein the video verification file or the set of video-encoded data is encrypted or decoded.

9. The system of claim 8, wherein the encryption or encoding at least in part comprises a digital rights management (DRM) encoding.

10. The system of claim 9, further comprising a digital rights management (DRM) component configured to determine whether the encryption or encoding does at least in part comprise the DRM encoding, and to decrypt or decode the video verification file or the set of video-encoded data in response to the encryption or encoding comprising the DRM encoding.

11. The system of claim 10, wherein the playback component is configured to play the set of video-encoded data in response to the DRM component determining the encryption or encoding to at least in part comprise the DRM encoding, and in response to the DRM component decrypting or decoding the video verification file or the set of video-encoded data.

12. The system of claim 11, wherein the playback component is further configured to play a DRM decoding error on the network-enabled television in response to the DRM component incorrectly decoding the video verification file or the set of video-encoded data.

13. The system of claim 1, further comprising a content management component configured to receive information associating the network-enabled television with a network content services account maintained by the network server.

14. The system of claim 13, wherein the content management component is further configured to store content service features provided to the network content services account by the network server in response to the associating the network-enabled television with the network content services account.

15. A system, comprising:
a memory storing computer-executable components;
a processor communicatively connected to the memory and configured to facilitate execution of at least one of the computer-executable components, the computer-executable components comprising:
a communication component configured to receive a request for a verification code over a communication network;
a code engine configured to generate a distinct verification code in response to the request, and to store the distinct verification code in a data store;
an encoding component configured to create the distinct verification code as a picture and convert the picture of the distinct verification code into a set of video frames, wherein the communication component responds to the request at least in part with reference to the set of video frames; and
a verification component configured to receive data over the communication network and determine whether the received data comprises the distinct verification code, and further configured to link a display device to a network content user account related to the system in response to the received data comprising the distinct verification code.

16. The system of claim 15, included within an Internet-enabled data server.

17. The system of claim 15, wherein the network communication platform is a webpage accessible by the verification component.

18. The system of claim 15, the verification component is further configured to authorize a login event at the network communication platform based on stored login credentials of one or more network content user accounts maintained by the system.

19. The system of claim 15, wherein the code engine is configured to extract identifying information pertaining to the display device from the request, and to generate the distinct verification code at least in part from the identifying information.

20. The system of claim 15, further comprising an account services component configured to allocate one or more reserved content services for the network content user account, in response to linking the display device to the network content user account.

21. The system of claim 20, wherein the one or more reserved content services is selected from a set of reserved content services at least in part from identifying information pertaining to the display device.

22. The system of claim 20, wherein the one or more reserved content services is selected from a set of reserved content services at least in part from a number of linked communication services connected to the network content user account.

23. The system of claim 20, wherein the one or more reserved content services is selected from a set of reserved content services at least in part from a type of linked communication services connected to the network content user account.

24. The system of claim 20, wherein the one or more reserved content services is selected from the set of reserved content services at least in part in response to establishment of a single sign on user authorization or account registration that enables single sign on activity for the network content user account and at least one other network communication account.

25. A method of providing network media content, comprising:
initiating an application on a television device, the application related to facilitating authorization of a user of the television device to receive network media content on the television device, and the television device configured for transmitting and receiving data over a data network;
accessing a communication network in response to the initiating the application and sending a request to a network server for an authorization video;
receiving a video file in response to the request, the video file comprising an identification code rendered in the form of the video file; and
playing the video file on the television device to facilitate user submission of the identification code as a response to the network server.

26. The method of claim 25, wherein the initiating the application is in response to detecting a power-on event at the television device.

27. The method of claim 25, further comprising acquiring identifying information pertaining to the television device and including the identifying information within the request to the network server.

28. The method of claim 27, wherein acquiring identifying information pertaining to the television device further comprises obtaining information related to a technical specification, a manufacturer, a model, or a serial number of the television device, or a combination thereof.

29. The method of claim 25, further comprising initiating a digital rights management application in response to receiving the video file, and obtaining a decoded video file in response to the digital rights management application determining the television device or the video file is consistent with digital rights management standards.

30. The method of claim 29, further comprising displaying a digital rights management error at the television device in response to the digital rights management application determining the television device or the video file is inconsistent with digital rights management standards.

31. A system, comprising:
means for initiating a network communication on a data network that is communicatively connected to a network-enabled television;
means for sending a request to a network server for an authorization video;
means for receiving a video file in response to the request, the video file comprising an identification code rendered in the form of a video file; and
means for playing the video file on the television device to facilitate user submission of the identification code as a response to the network server.
